(19) United States
(12) Patent Application Publication
(10) Pub. No.: US 2012/0293640 A1
(43) Pub. Date: Nov. 22, 2012

(54) THREE-DIMENSIONAL VIDEO DISPLAY APPARATUS AND METHOD

(76) Inventors: Ryusuke Hirai, Tokyo (JP); Takeshi Mita, Yokohama-shi (JP); Kenichi Shimoyama, Tokyo (JP); Yoshiyuki Kokojima, Yokohama-shi (JP); Rieko Fukushima, Tokyo (JP); Masahiro Baba, Yokohama-shi (JP)

(21) Appl. No.: 13/561,549

(22) Filed: Jul. 30, 2012

Related U.S. Application Data
(63) Continuation of application No. PCT/JP2010/071389, filed on Nov. 30, 2010.

(51) Int. Cl. H04N 13/04

(52) U.S. Cl. 348/54; 348/E13.026

(57) ABSTRACT

According to one embodiment, a three-dimensional video display apparatus includes a display, a calculator and a generator. The display displays a plurality of images with different viewpoints by using a plurality of light beam control elements to control light beams from pixels. The calculator calculates a quality of view for each of viewing positions with respect to the display based on a number of the light beam control elements causing pseudoscopy at each of the viewing positions. The generator generates a map indicating the quality of view for each of the viewing positions.

### CROSS REFERENCE TO RELATED APPLICATIONS

This application is a Continuation application of PCT Application No. PCT/JP2010/071389, filed Nov. 30, 2010, the entire contents of which are incorporated herein by reference.

### FIELD

Embodiments described herein relate generally to the display of three-dimensional videos.

### BACKGROUND

According to a certain three-dimensional video display apparatus, a viewer can view three-dimensional videos without using special glasses (that is, with the naked eye). This three-dimensional video display apparatus displays a plurality of images with different points of view and controls the directions of their light beams using light beam control elements (for example, a parallax barrier and a lenticular lens). The light beams with the directions thereof controlled are guided to the viewer's right and left eyes. If the viewing position is appropriate, the viewer can recognize the three-dimensional video.

A problem with this three-dimensional video display apparatus is limited regions in which three-dimensional videos can be appropriately viewed. For example, at certain viewing positions, a viewpoint for an image perceived by the left eye is rightward relative to a viewpoint for an image perceive by the right eye, precluding the three-dimensional video from being correctly recognized. Such viewing positions are called pseudoscopic regions. Thus, a viewing assistance function is useful which, for example, allows the viewer to recognize regions where the viewer can properly view autostereoscopic three-dimensional videos.

### BRIEF DESCRIPTION OF THE DRAWINGS

FIG. 1 is a block diagram illustrating a three-dimensional video display apparatus according to a first embodiment;

FIG. 2 is a flowchart illustrating an operation of the three-dimensional video display apparatus in FIG. 1;

FIG. 3 is a block diagram illustrating a three-dimensional video display apparatus according to a second embodiment;

FIG. 4 is a flowchart illustrating an operation of the three-dimensional video display apparatus in FIG. 3;

FIG. 5 is a block diagram illustrating a three-dimensional video display apparatus according to a third embodiment;

FIG. 6 is a flowchart illustrating an operation of the three-dimensional video display apparatus in FIG. 5;

FIG. 7 is a block diagram illustrating a three-dimensional video display apparatus according to a fourth embodiment;

FIG. 8 is a flowchart illustrating an operation of the three-dimensional video display apparatus in FIG. 7;

FIG. 9 is a block diagram illustrating a three-dimensional video display apparatus according to a fifth embodiment;

FIG. 10 is a flowchart illustrating an operation of the three-dimensional video display apparatus in FIG. 9;

FIG. 11 is a diagram illustrating the principle of autoscteroscopy;

FIG. 12 is a diagram illustrating viewpoint images perceived by the right and left eyes;

FIG. 13 is a diagram illustrating the periodicity of a luminance profile;

FIG. 14 is a diagram illustrating the periodicity of a viewpoint luminance profile;

FIG. 15A is a diagram illustrating pseudoscopy;

FIG. 15B is a diagram illustrating pseudoscopy;

FIG. 16A is a diagram illustrating viewpoint selection;

FIG. 16B is a diagram illustrating viewpoint selection;

FIG. 17 is a diagram illustrating the position of a light beam control element;

FIG. 18 is a diagram illustrating a viewing position;

FIG. 19 is a diagram illustrating a luminance profile;

FIG. 20 is a diagram illustrating a viewpoint luminance profile;

FIG. 21 is a diagram illustrating a region of normal stereoscopy;

FIG. 22 is a diagram illustrating a technique to generate a viewpoint image;

FIG. 23 is a diagram illustrating a map;

FIG. 24 is a block diagram illustrating a map generation apparatus according to the first embodiment; and

FIG. 25 is a block diagram illustrating a modification of the three-dimensional video display apparatus in FIG. 1.

### DETAILED DESCRIPTION

Embodiments will be described below with reference to the drawings.

In general, according to one embodiment, a three-dimensional video display apparatus includes a display, a calculator and a generator. The display displays a plurality of images with different viewpoints by using a plurality of light beam control elements to control light beams from pixels. The calculator calculates a quality of view for each of viewing positions with respect to the display based on a number of the light beam control elements causing pseudoscopy at each of the viewing positions. The generator generates a map indicating the quality of view for each of the viewing positions.

Components of each embodiment which are identical or similar to those of other embodiments already described are denoted by identical or similar reference numerals. Duplicate descriptions are basically omitted.

### First Embodiment

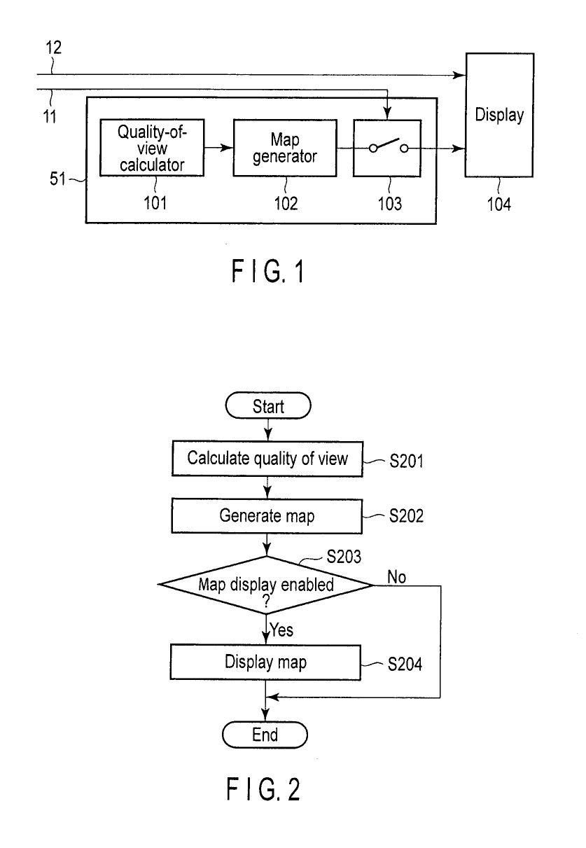

As shown in FIG. 1, a three-dimensional video display apparatus according to a first embodiment comprises a presenter 51 and a display 104. The presenter 51 includes a quality-of-view calculator 101, a map generator 102, and a selector 103.

The display 104 displays a plurality of viewpoint images (signals) contained in a three-dimensional video signal 12. The display 104 is typically a liquid crystal display but may be any other display such as a plasma display or an organic light-emitting diode (OLED) display.

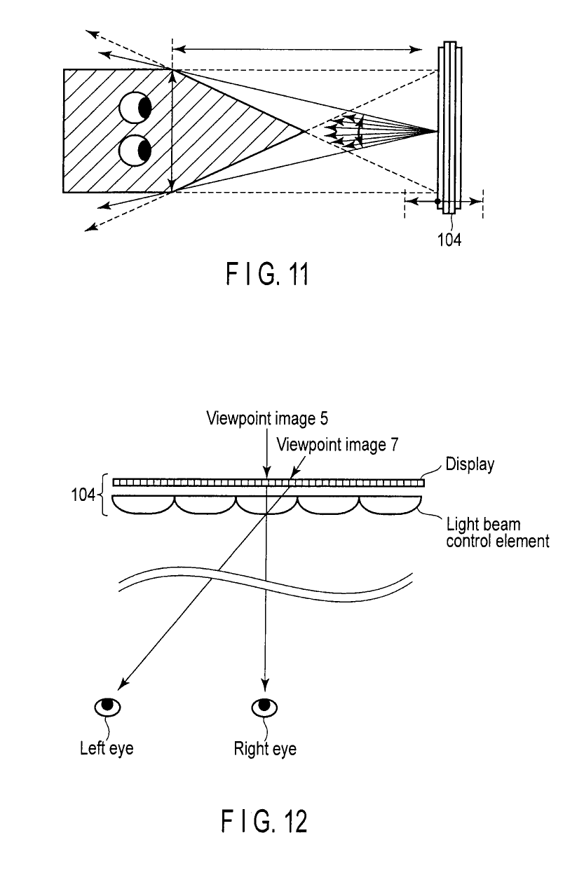

The display 104 comprises a plurality of light beam control elements (for example, a parallax barrier and a lenticular lens) on a panel thereof. As shown in FIG. 11, light beams for the plurality of viewpoint images are separated from one another by the light beam control elements, for example, in the horizontal direction, and guided to a viewer's eyes. The light beam control elements may of course be arranged on the panel so as to separate the light beams from one another in another direction such as the vertical direction.

The light beam control elements provided in the display 104 have a characteristic for radiance (hereinafter referred to as a luminance profile). For example, the profile may be the decay rate at which light emitted by the display at the maximum luminance decays upon passing through the light beam control element.

For example, as shown in FIG. 19, each of the light beam control elements separate light beams for viewpoint images (subpixels) 1, . . . , and 9. In the following description, the nine viewpoint images 1, . . . , and 9 are displayed. Of the viewpoint images 1, . . . , and 9, the viewpoint image 1 corresponds to the rightmost viewpoint, and the viewpoint image 9 corresponds to the leftmost viewpoint. That is, pseudoscopy does not occur when the index of the viewpoint image entering the left eye is larger than that of the viewpoint image entering the right eye. The light beam for the viewpoint image 5 is most intensely radiated at an angle of direction θ=0. The luminance profile can be created by measuring the intensity of a light beam for each viewpoint image radiated at the angle of direction θ, using a luminance meter or the like. The angle of direction θ in this case falls within the range of −π/2≦θ≦π/2. That is, the luminance profile depends on the configuration of (the light beam control elements provided in) the display 104.

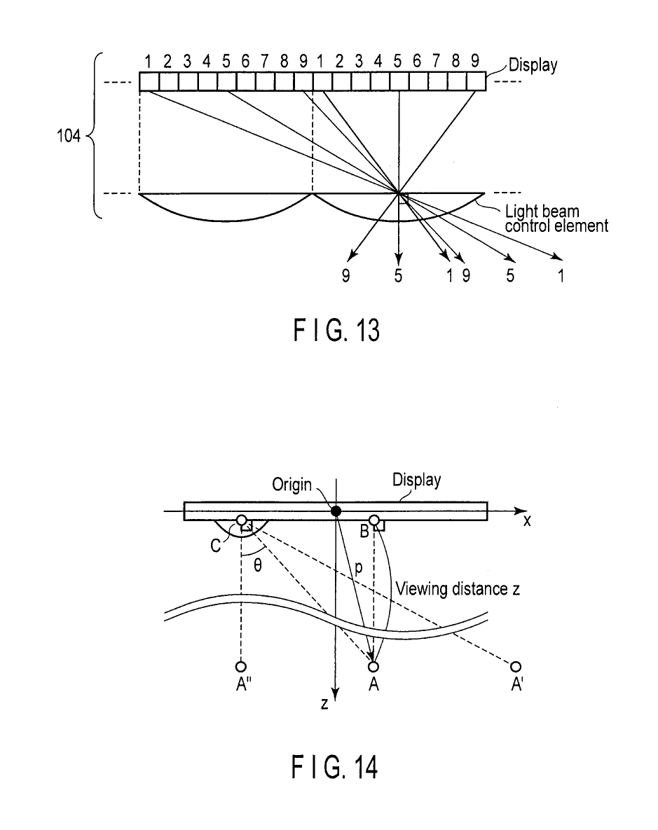

Only the pixels lying behind the light beam control elements have been described with reference to FIG. 19. In the actual display 104, light beam control elements and subpixels are arranged as shown in FIG. 13. Hence, a more acute angle of direction θ increases the amount of light observed which travels from a subpixel lying behind a light beam control element next to a light beam control element with the luminance profile thereof being measured. However, the distance between the light beam control element and the subpixel is short, and thus a difference in optical path from the subpixel located below the next light beam control element is small. Thus, the luminance profile can be considered to be periodic with respect to the angle of direction θ. Furthermore, as can be seen in FIG. 13, the period can be determined based on design information such as the distance between the light beam control element and the display, the size of each subpixel, and the characteristics of the light beam control element.

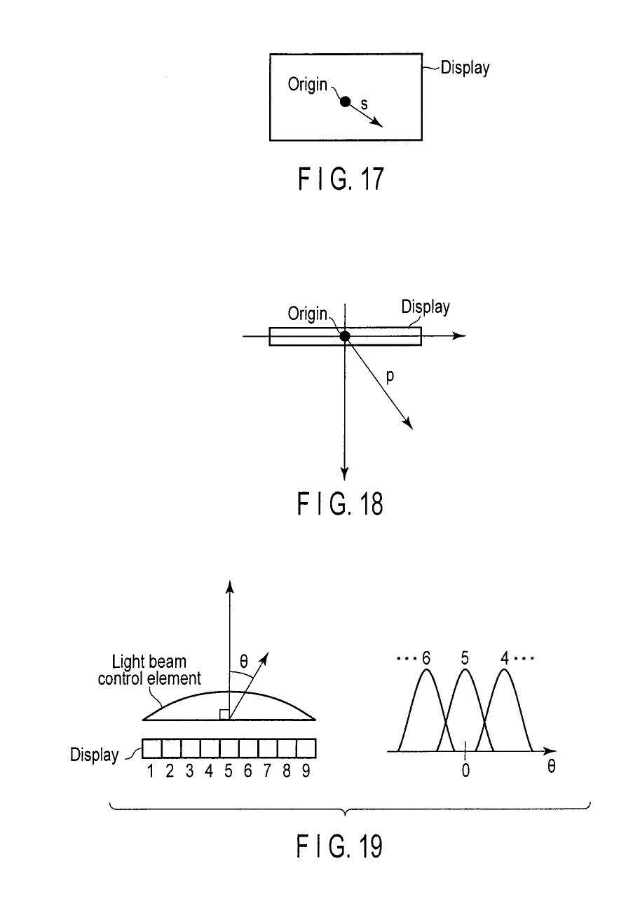

The position of each of the light beam control elements provided in the display 104 can be expressed by a position vector s from a start point (origin) corresponding to the center of the display 104, as shown in FIG. 17. Moreover, each viewing position can be expressed by a position vector p from the start point (origin) corresponding to the center of the display 104, as shown in FIG. 18. FIG. 18 is a bird's-eye view of the display 104 and its surroundings as can be seen from the vertical direction. That is, the viewing position is defined on a plane with respect to which the display 104 and its surroundings as can be seen from the vertical direction.

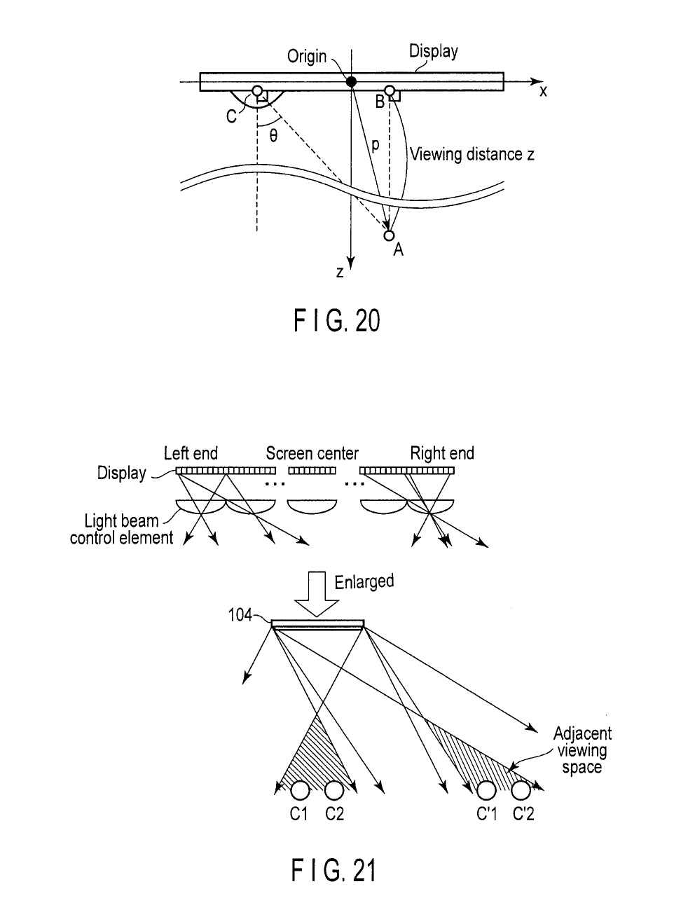

At a viewing position for the position vector p, a luminance perceived as a result of light beams from the light beam control element with the position vector s can be derived as follows using FIG. 20. In FIG. 20, a point C represents the position of the light beam control element, and a point A represents the viewing position (for example, the position of the viewer's eyes). Furthermore, a point B represents the foot of a perpendicular from point A to the display 104. Moreover, θ represents the angle of direction of point A based on point C. According to the above-described luminance profile, the radiance of a light beam for each viewpoint image can be calculated based on the angle of direction θ. The angle of direction θ can be geometrically calculated, for example, in accordance with:

$$θ = {tan}^{- 1} \frac{\overline{BC}}{\overline{AB}} \qquad ( 1 )$$

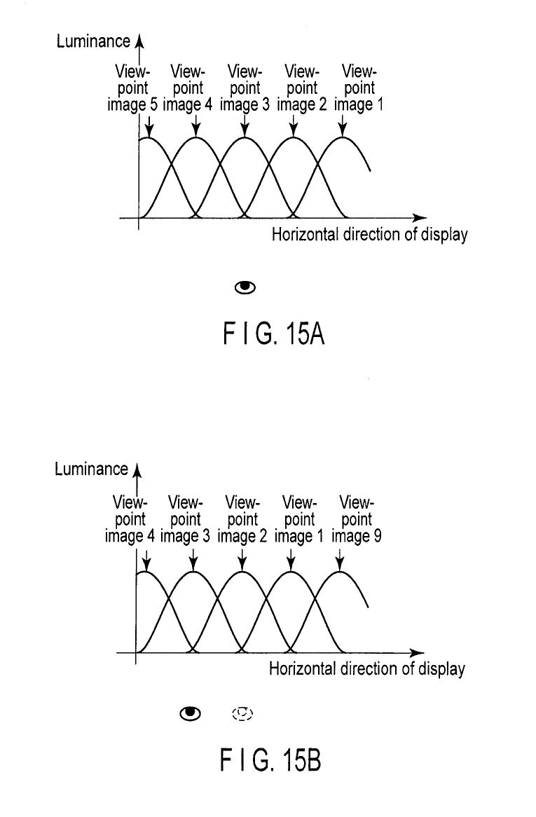

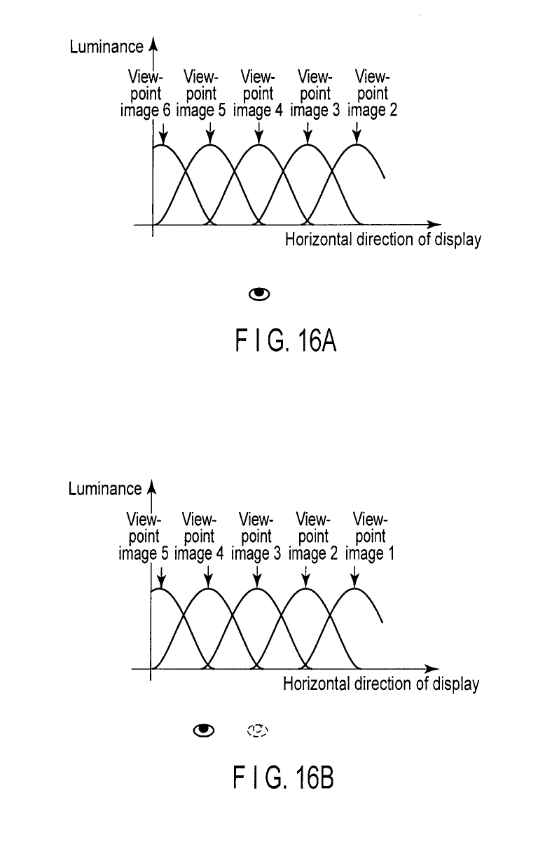

That is, such luminance profiles as shown in FIG. 15A, FIG. 15B, FIG. 16A, and FIG. 16B are obtained by calculating the radiances from all the light beam control elements at any viewing position. In the following description, the luminance profile for each viewing position is referred to as a viewpoint luminance profile in order to distinguish this luminance profile from the above-described luminance profile for each light beam control element.

Furthermore, the angle of direction θ and the periodicity of the luminance profile indicate that viewpoint luminance profile is also periodic. For example, in FIG. 14, it is assumed that at a position A, the viewer can observe light from a subpixel for the viewpoint image 5 lying behind a light beam control element located to the left and adjacent to point C. In this case, due to the periodicity of the angle of direction θ, at a position A′, the viewer can observe a subpixel for the viewpoint image 5 lying behind a light beam control element located to the left and adjacent to the light beam control element located to the left and adjacent to point C. Similarly, at a position A″, the viewer can observe a subpixel for the viewpoint image 5 lying behind a light beam control element at point C. The subpixels for a viewpoint image i are arranged at equal intervals, and thus points A, A′ and A″, for which perpendiculars from the display are the same in size, are arranged at equal intervals.

The use of the viewpoint luminance profile allows a pixel value perceived as a result of a light beam for the viewpoint image i traveling from the light beam control element with the position vector s to be expressed by Expression (2) shown below. Here, the viewpoint images 1, . . . , and 9 are defined as indices i=1, . . . , and 9, respectively. Furthermore, the viewpoint luminance profile is defined as a( ). Additionally, the pixel value of the viewpoint image i for a subpixel lying behind a light beam control element w is defined as x(w, i).

$$y ( s , p , i ) = {\sum }_{w ∈ Ω}^{ } a ( s , p , w , i ) x ( w , i ) \qquad ( 2 )$$

Here, Ω denotes a set including the position vectors s of all the light beam control elements provided in the display 104. In this case, light beam outputs from the position s of a light beam control element contains not only a light beam from a subpixel lying behind the light beam control element with the position vector s but also light beams from subpixels surrounding the above-described subpixel. Thus, Expression (2) calculates the sum of the pixel value of the pixel lying behind the light beam control element with the position vector s and the pixel values of subpixels surrounding the pixel.

Expression (2) can be rewritten using a vector as follows:

y(s,p,i)=a(s,p,i)x(i) (3)

That is, when the total number of viewpoint images is denoted by N, the luminance perceived at the viewing position with the position vector p as a result of a light beam for each viewpoint image traveling from the light beam control element with the position vector s can be expressed by:

$$y ( s , p ) = {\sum }_{i = 1}^{N} a ( s , p , i ) x ( i ) \qquad ( 4 )$$

Utilizing Expressions (5) and (6) shown below, Expression (4) can be rewritten as Expression (7) shown below.

â(s,p)=(a(s,p,1) . . . a(s,p,9)) (5)

X=(x(1) . . . x(9))^{T} (6)

Y(s,p)=â(s,p)X (7)

Moreover, if an image that can be observed at the viewing position is assumed to be a one-dimensional vector Y(p), the one-dimensional vector Y can be expressed by:

Y(p)=A(p)X (8)

Now, Expression (8) will be intuitively described. For example, as shown in FIG. 12, among the light beams from the central light beam control element, the light beam for the viewpoint image 5 is perceived by the right eye, and the light beam for the viewpoint image 7 is perceived by the left eye. Hence, the viewer's right and left eyes perceive the different viewpoint images, and the parallax between the viewpoint images enables stereopsis. That is, different videos are perceived at different viewing positions p, enabling stereopsis.

The quality-of-view calculator 101 calculates quality of view at each viewing position with respect to the display 104. For example, even in the region of normal stereoscopy, where the viewer can correctly view the stereoscopic video, the quality of view varies with the viewing position due to a factor such as the number of light beam control elements causing pseudoscopy. Thus, effective assistance for viewing can be achieved by calculating the quality of view at each viewing position with respect to the display 104 and utilizing the quality of view as an index for the quality of the stereoscopic video at each viewing position.

The quality-of-view calculator 101 calculates the quality of view for each viewing position based at least on the characteristics of the display 104 (for example, the luminance profile and the viewpoint luminance profile). The quality-of-view calculator 101 inputs the quality of view calculated for each viewing position to the map generator 102.

For example, the quality-of-view calculator 101 calculates a function ε(s) in accordance with Expression (9) shown below. The function ε(s) returns 1 if the light beam control element with the position vector s causes pseudoscopy and returns 0 if the light beam control element with the position vector s avoids causing pseudoscopy.

$$ɛ ( s , p ) = \{ \begin{matrix}0 & [ arg {max}_{i} {\vert a ( s , p + \frac{d}{2} , i ) \vert}_{L} - arg {max}_{i} {\vert a ( s , p - \frac{d}{2} , i ) \vert}_{L} > 0 ] \\ 1 & otherwise\end{matrix} \qquad ( 9 )$$

In the following description, ∥_{L} denotes a vector norm, and an L1-norm or an L2-norm is used.

Here, the position vector p points to the center of the right and left eyes of the viewer. In the following description, d denotes a binocular parallax vector. That is, a vector p+d/2 points to the viewer's left eye. A vector p−d/2 points to the viewer's right eye. If the index of a viewpoint image most clearly perceived by the viewer's left eye is larger than that of a viewpoint image most clearly perceived by the viewer's right eye, ε(s) is 1. Otherwise ε(s) is 0.

Moreover, the quality-of-view calculator 101 uses the function ε(s) calculated in accordance with Expression (9) to calculate the quality of view Q₀ at the viewing position with the position vector p in accordance with:

$${Q}_{0} ( p ) = exp ( - \frac{( {\sum }_{s ∈ Ω}^{ } ɛ ( s , p ) )}{2 {σ}_{1}^{2}} ) \qquad ( 10 )$$

In Expression (10), σ₁ is a constant having a value that increases with the number of light beam control elements provided in the display 104. Furthermore, Ω denotes a set including the position vectors s of all the light beam control elements provided in the display 104. The quality of view Q₀ allows the number of light beam control elements causing pseudoscopy to be evaluated (allows evaluation of how few light beam control elements are provided in the display 104 are). The quality-of-view calculator 101 may output the quality of view Q₀ as the final quality of view or may perform a different calculation as described below.

For example, the quality-of-view calculator 101 may calculate ε(s) in accordance with Expression (11) instead of Expression (9) described above.

$$ɛ ( s , p ) = \{ \begin{matrix}0 & [ \begin{matrix}arg {max}_{i} {\vert a ( s , p + \frac{d}{2} , i ) \vert}_{L} - \\ arg {max}_{i} {\vert a ( s , p - \frac{d}{2} , i ) \vert}_{L} > 0\end{matrix} ] \\ exp ( - \frac{{\vert s \vert}_{L}}{2 {σ}_{2}^{2}} ) & otherwise\end{matrix} \qquad ( 11 )$$

In Expression (11), σ₂ denotes a constant having a value that increases with the number of light beam control elements provided in the display 104. Expression (11) takes into account the subjective property that pseudoscopy occurring at the end of the screen is more unnoticeable than that occurring at the center of the screen. That is, the value returned by ε(s) if pseudoscopy occurs is smaller for a light beam control element with a longer distance from the center of the display 104.

Furthermore, the quality-of-view calculator 101 may calculate Q₁ in accordance with Expression (12) shown below and use Q₁ and the above-described Q₀ to calculate the final quality of view Q in accordance with Expression (13) shown below. Alternatively, the quality-of-view calculator 101 may calculate the final quality of view Q to be Q1 instead of the above-described Q₀.

$$\begin{matrix}{Q}_{1} ( p ) = exp ( - \frac{{\vert p - c ( p ) \vert}_{L}}{2 {σ}_{3}^{2}} ) & ( 12 ) \\ Q ( p ) = {Q}_{0} ( p ) {Q}_{1} ( p ) & ( 13 )\end{matrix}$$

In Expression (12), σ₃ is a constant having a value increasing with the number of light beam control elements provided in the display 104.

Expression (8) indicates that a perceived image is expressed by the linear sum of the viewpoint images. The viewpoint luminance profile matrix A(p) in Expression (8) corresponds to a positive definite matrix and thus undergo a type of low pass filter operation, leading to blurred images. Thus, a method has been proposed in which a viewpoint image X to be displayed is specified by preparing a sharp unblurred image Ŷ(p) (the second term on the left side of Expression (14)) for a viewpoint p and minimizing energy E defined by Expression (14).

E=|A(p)X−Ŷ(p)|_{L} (14)

The energy E can be rewritten as Expression (15) shown below. When the center of the right and left eyes is located at such viewing position p as allows Expression (15) to be minimized, a sharp image with the adverse effect of blurring reduced in accordance with Expression (8) can be observed. One or more such viewing positions p may be set and are hereinafter represented as set viewpoints Cj.

$$E = {\vert ( \begin{matrix}A ( p + \frac{d}{2} ) \\ A ( p - \frac{d}{2} )\end{matrix} ) x - ( \begin{matrix}\hat{Y} ( p + \frac{d}{2} ) \\ \hat{Y} ( p - \frac{d}{2} )\end{matrix} ) \vert}_{L} \qquad ( 15 )$$

For example, C1 and C2 in FIG. 21 denote the set viewpoints. A viewpoint luminance profile matrix with values that are almost the same as those of the set viewpoints also appears periodically at different viewpoint positions as described above. Thus, for example, C′1 and C′2 in FIG. 21 can also be considered to be set viewpoints. One of these set viewpoints which is closest to the viewing position p is denoted as C(p) in Expression (7). The quality of view Q₁ allows the deviation of the viewing position from the set viewpoint to be evaluated (allows evaluation of how slightly the viewing position deviates from the set viewpoint).

The map generator 102 generates a map that presents the viewer with the quality of view for each viewing position provided by the quality-of-view calculator 101. The map is typically an image in which the quality of view for each viewing region is expressed by a corresponding color as shown in FIG. 23. However, the map is not limited to such an image and may be any type of information that allows the viewer to determine the quality of view for each viewing position. The map generator 102 inputs a map generated to the selector 103.

The selector 103 selectively determines whether to enable or disable display of the map from the map generator 102. For example, as shown in FIG. 1, the selector 103 selectively determines whether to enable or disable the display of the map in accordance with a user control signal 11. The selector 103 may selectively determine whether to enable or disable the display of the map in accordance with any other condition. For example, the display of the map may be enabled until a predetermined time elapses from the beginning of the display of the three-dimensional video signal 12 by the display 104 and may then be disabled. When the selector 103 enables the display of the map, the map from the map generator 102 is supplied to the display 104 via the selector 103. The display 104 can display the map, for example, so that the map is superimposed on the three-dimensional video signal 12 being displayed.

An operation of the three-dimensional video display apparatus in FIG. 1 will be described below with reference to FIG. 2.

When processing starts, the quality-of-view calculator 101 calculates the quality of view for each viewing position with respect to the display 104 (step S201). The map generator 102 generates a map that presents the viewer with the quality of view for each viewing position calculated in step S201 (step S202).

The selector 103 determines whether or not the map display is enabled, for example, in accordance with the user control signal 11 (step S203). When the map display is determined to be enabled, the processing proceeds to step S204. In step S204, the display 104 displays the map generated in step S202 so that the map is superimposed on the three-dimensional video signal 12. Then, the processing ends. On the other hand, if the map display is determined to be disabled in step S203, step S204 is omitted. That is, the display 104 refrains from displaying the map generated in step S202. Then, the processing ends.

As described above, the three-dimensional video display apparatus according to the first embodiment calculates the quality of view for each viewing position with respect to the display, and generates a map that presents the quality of view to the viewer. Thus, the three-dimensional video display apparatus according to the present embodiment allows the viewer to easily determine the quality of view for each viewing position. In particular, the map generated by the three-dimensional video display apparatus according to the present embodiment not only presents the region of normal stereoscopy but also presents multiple levels of the quality of view in the region of normal stereoscopy. Therefore, the three-dimensional video display apparatus according to the present embodiment is useful for assisting in viewing three-dimensional images.

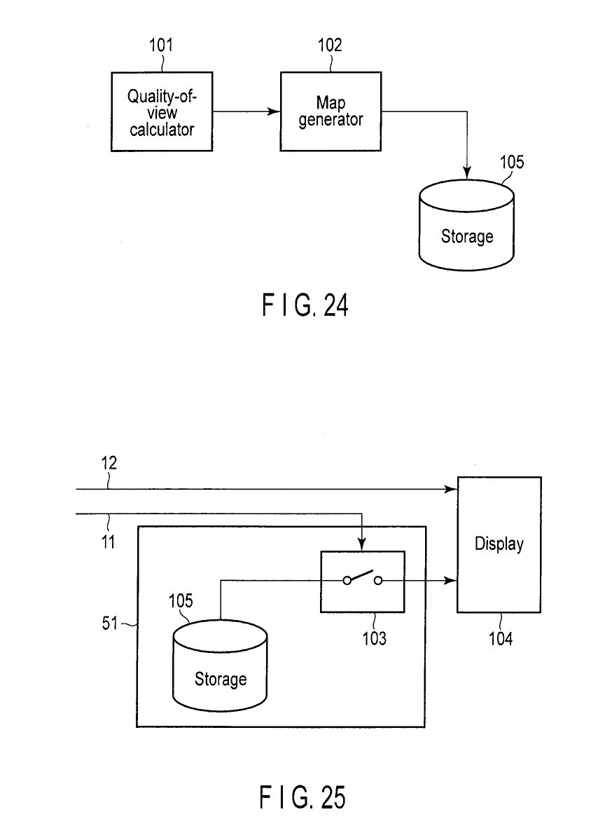

In the present embodiment, the quality-of-view calculator 101 calculates the quality of view for each viewing position based on the characteristics of the display 104. That is, the determined characteristics of the display 104 enable the quality of view for each viewing position to be pre-calculated and a map to be pre-generated. Saving a pre-generated map in a storage (memory or the like) allows similar effects to be exerted even when the quality-of-view calculator 101 and map generator 102 in FIG. 1 are replaced with the storage. Thus, the present embodiment also aims to provide a map generation apparatus including the quality-of-view calculator 101, the map generator 102, and a storage 105 as shown in FIG. 24. Moreover, the present embodiment aims to provide a three-dimensional video display apparatus including the storage 105 in which the map generated by the map generation apparatus in FIG. 24 is stored, (the selector 103 as needed,) and the display as shown in FIG. 25.

### Second Embodiment

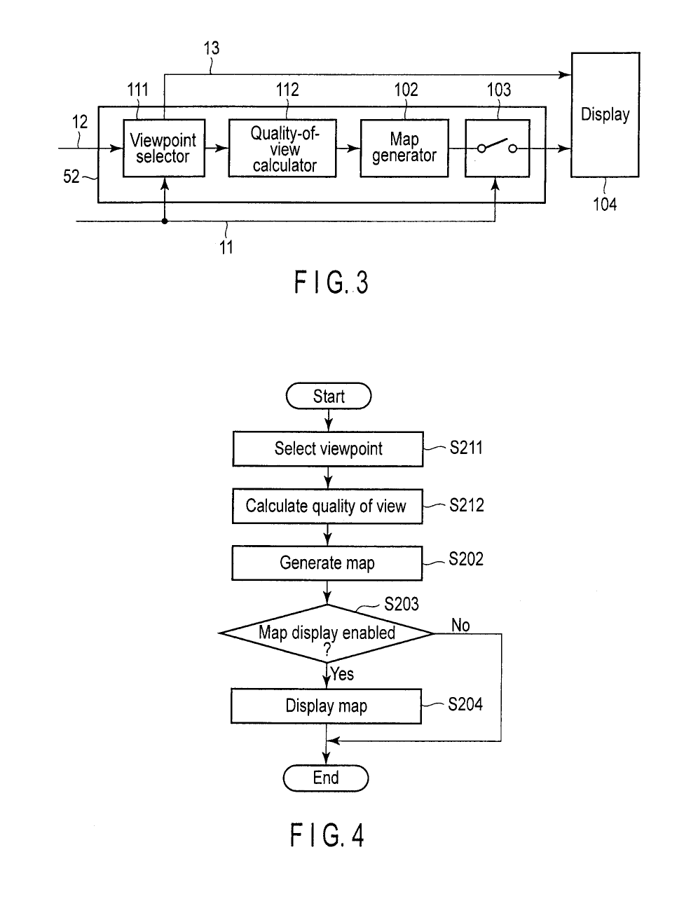

As shown in FIG. 3, a three-dimensional video display apparatus according to a second embodiment comprises a presenter 52 and a display 104. The presenter 52 includes a viewpoint selector 111, a quality-of-view calculator 112, a map generator 102, and a selector 103.

The viewpoint selector 111 receives a three-dimensional video signal 12 and selects a display order for a plurality of viewpoint images contained in the three-dimensional video signal 12, in accordance with a user control signal 11. A three-dimensional video signal 13 with the display order selected is supplied to the display 104. Moreover, the quality-of-view calculator 112 is notified of the selected display order. Specifically, for example, in accordance with the user control signal 11 specifying any position in a map, the viewpoint selector 111 selects a display order for the viewpoint images so that the specified position is contained in a region of normal stereoscopy (or so as to maximize the quality of view at the specified position).

In an example illustrated in FIG. 15A and FIG. 15B, a pseudoscopic region is present to the right of the viewer. When such a display order of viewpoint images is shifted rightward by one image, the viewpoint images perceived by the viewer are shifted rightward by one image as shown in FIG. 16A and FIG. 16B. In other words, the region of normal stereoscopy and the pseudoscopic region are each shifted rightward. Such selection of the display order enables a change in the region of normal stereoscopy and the quality of view at the specified position.

The quality-of-view calculator 112 calculates the quality of view for each viewing position based on the characteristics of the display 104 and the display order selected by the viewpoint selector 111. That is, for example, x(i) in Expression (3) varies depending on the display order selected by the viewpoint selector 111, and thus based on this, the quality-of-view calculator 112 needs to calculate the quality of view for each viewing position. The quality-of-view calculator 112 inputs the calculated quality of view for viewing position to the map generator 102.

The three-dimensional video display apparatus in FIG. 3 will be described below with reference to FIG. 4.

When processing starts, the viewpoint selector 111 receives the three-dimensional video signal 12. The viewpoint selector 111 then selects a display order for a plurality of viewpoint images contained in the three-dimensional video signal in accordance with the user control signal 11, and supplies the resulting three-dimensional video signal 13 to the display 104 (step S211).

Then, the quality-of-view calculator 112 calculates the quality of view for each viewing position based on the characteristics of the display 104 and the display order selected by the viewpoint selector 111 in step S211 (step S212).

As described above, the three-dimensional video display apparatus according to the second embodiment selects a display order for the viewpoint images so that the specified position is included in the region of normal stereoscopy or so as to maximize the quality of view at the specified position. Thus, the three-dimensional video display apparatus according to the present embodiment allows the viewer to ease restrictions of a viewing environment (the arrangement of furniture and the like) and to improve the quality of view of a three-dimensional video at the desired viewing position.

In the present embodiment, the quality-of-view calculator 112 calculates the quality of view for each viewing position based on the characteristics of the display 104 and the display order selected by the viewpoint selector 111. Here, the number of possible display orders one of which is selected by the viewpoint selector 111 (that is, the number of viewpoints) is finite. That is, maps can be generated by calculating the quality of view for each viewing position expected to result from each display order. The thus pre-generated maps associated with the respective display orders are saved in a storage (memory or the like), and a map corresponding to the display order selected by the viewpoint selector 111 is read when the three-dimensional video is displayed. Then, similar effects can be exerted even when the quality-of-view calculator 112 and the map generator 102 are replaced with the storage. Thus, the present embodiment also aims to provide a map generation apparatus including the quality-of-view calculator 112, the map generator 102, and a storage (not shown in the drawings). Moreover, the present embodiment aims to provide a three-dimensional video display apparatus including a storage (not shown in the drawings) in which maps pre-generated by the map generation apparatus and associated with the respective display orders are stored, the viewpoint selector 111, (the selector 103 as needed,) and the display 104.

### Third Embodiment

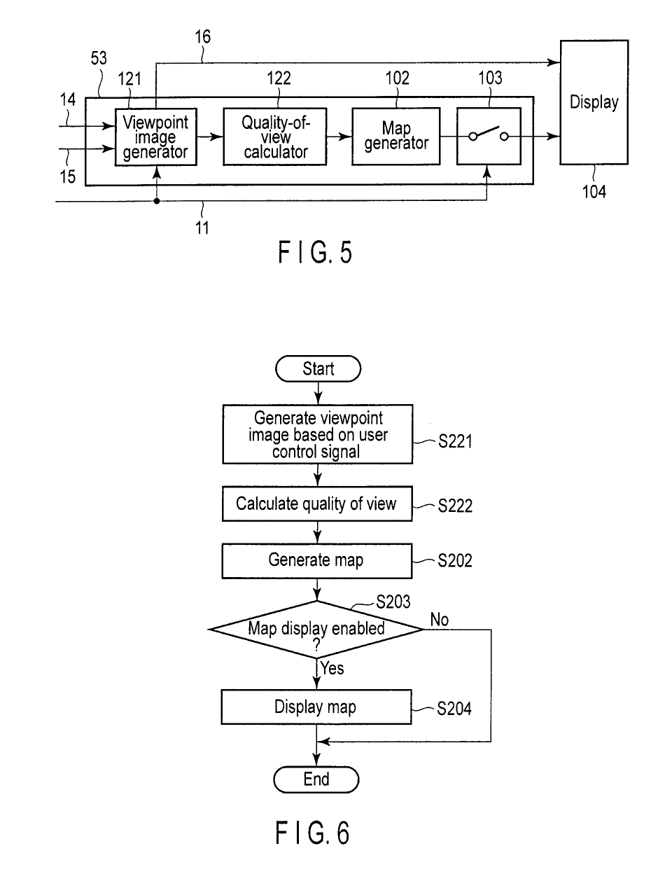

As shown in FIG. 5, a three-dimensional video display apparatus according to a third embodiment comprises a presenter 53 and a display 104. The presenter 53 includes a viewpoint image generator 121, a quality-of-view calculator 122, a map generator 102, and a selector 103.

The viewpoint image generator 121 receives a video signal 14 and a depth signal 15, generates a viewpoint image based on the video signal 14 and the depth signal 15, and supplies the display 104 with a three-dimensional video signal 16 containing the viewpoint image generated. The video signal 14 may be a two-dimensional signal (that is, one viewpoint image) or a three-dimensional image (that is, a plurality of viewpoint images). Various techniques to generate a desired viewpoint image based on the video signal 14 and the depth signal 15 are conventionally known. The viewpoint image generator 121 may utilize any of these techniques.

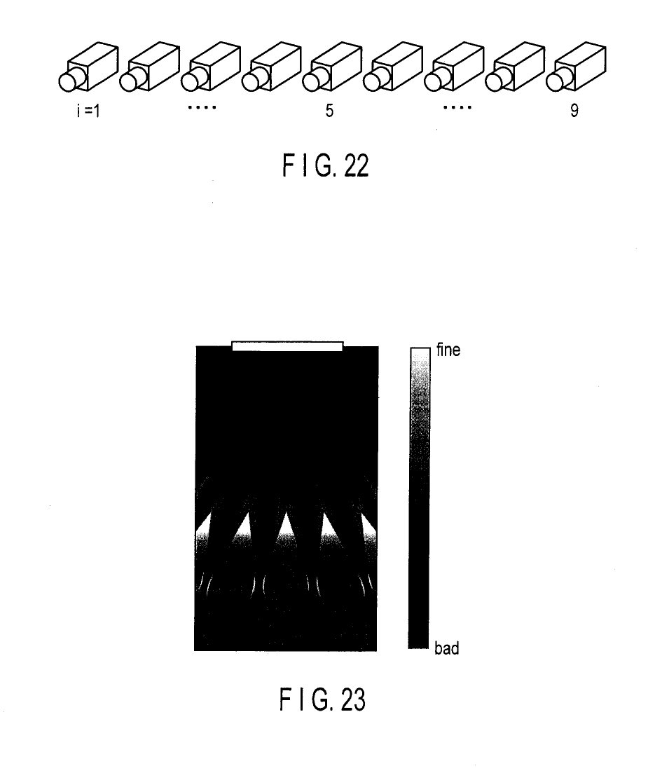

For example, as shown in FIG. 22, nine viewpoint images can be obtained when nine cameras are arranged side by side for image taking. However, typically, one or two viewpoint images taken by one or two cameras are input to the three-dimensional video display apparatus. A technique is known in which a viewpoint image not actually taken is virtually generated by estimating the depth value of each pixel from the one or two viewpoint images or directly acquiring depth values from the input depth signal 15. In regard to the example illustrated in FIG. 22, if a viewpoint image corresponding to i=5 is provided in the video signal 14, viewpoint images corresponding to i=1, . . . , 4, 6, . . . , and 9 can be virtually generated by adjusting the amount of parallax based on the depth value of each pixel.

Specifically, the viewpoint image generator 121 selects a display order for generated viewpoint images in accordance with a user control signal 11 specifying any position in the map, so as to improve the quality of a three-dimensional video perceived at the specified position. For example, with at least three viewpoints, the viewpoint image generator 121 selects a display order for the viewpoint images so that a viewpoint image with a small amount of parallax (from the video signal 14) is guided to the specified position. With two viewpoints, the viewpoint image generator 121 selects a display order for the viewpoint images so that the specified position is included in the region of normal stereoscopy. A quality-of-view calculator 122 is notified of the display order selected by the viewpoint image generator 121 and the viewpoint corresponding to the video signal 14.

Now, the following will be described in brief: the relationship between the guidance of a viewpoint image with a small amount of parallax to the specified position and the improvement of quality of the three-dimensional image at the specified position.

Occlusion is known as a factor that degrades the quality of a three-dimensional image generated based on the video signal 14 and the depth signal 15. That is, a region of the video signal 14 that cannot be referenced (a region that is not present in the video signal 14, for example, a region that is shielded by an object [hidden surface]) may need to be expressed in an image of a different viewpoint. The likelihood of this phenomenon generally increases with the distance from the viewpoint for the video signal 14, that is, the amount of parallax with respect to the video signal 14. For example, in the example illustrated in FIG. 22, if a viewpoint image corresponding to i=5 is provided in the video signal 14, a region that is not present in the viewpoint image corresponding to i=5 (hidden surface) may be larger in a viewpoint image corresponding to i=9 than in a viewpoint image corresponding to i=6. Thus, the quality of the three-dimensional image can be restrained from being degraded due to occlusion by allowing the viewer to view viewpoint images with small amounts of parallax.

The quality-of-view calculator 122 calculates the quality of view for each viewing position based on the characteristics of the display 104, the display order selected by the viewpoint image generator 121, and the viewpoint corresponding to the video signal 14. That is, the quality-of-view calculator 122 needs to calculate the quality of view based on the following nature: x(i) in Expression (3) varies depending on the display order selected by the viewpoint image generator 121, and the quality of the three-dimensional image decreases with increasing distance from the viewpoint for the video signal 14. The quality-of-view calculator 122 inputs the calculated quality of view for each viewing position to the map generator 102.

Specifically, the quality-of-view calculator 122 calculates a function λ(s, p, iₜ) in accordance with Expression (16) shown below. For simplification, Expression (16) assumes that video signal 14 corresponds to one viewpoint image. The value of the function λ(s, p, iₜ) decreases with the distance between the viewpoint iₜ of the video signal 14 and the viewpoint of a viewpoint image perceived at a viewing position with a viewing position vector p.

$$λ ( s , p , {i}_{t} ) = \vert arg {max}_{i} {\vert a ( s , p + \frac{d}{2} , i ) \vert}_{L} - {i}_{t} \vert + \vert arg {max}_{i} {\vert a ( s , p - \frac{d}{2} , i ) \vert}_{L} - {i}_{t} \vert \qquad ( 16 )$$

Moreover, the quality-of-view calculator 122 uses the function λ(s, p, iₜ) calculated in accordance with Expression (16) to calculate the quality of view Q₂ at the viewing position with the position vector p in accordance with:

$${Q}_{2} ( p ) = exp \{ - \frac{{( {\sum }_{s ∈ Ω}^{ } λ ( s , p , {i}_{t} ) )}^{2}}{2 {σ}_{4}^{2}} \} \qquad ( 17 )$$

In Expression (17), σ₄ denotes a constant having a value that increases with the number of light beam control elements provided in the display 104. Furthermore, Ω denotes a set including the position vectors s of all the light beam control elements provided in the display 104. The quality of view Q₂ allows the degree of degradation of the quality of a three-dimensional image caused by occlusion to be evaluated. The quality-of-view calculator 122 may output the quality of view Q₂ as the final quality of view Q or may combine the quality of view Q₂ with the above-described quality of view Q₀ or Q₁ to calculate the final quality of view Q. That is, the quality-of-view calculator 122 may calculate the final quality of view Q in accordance with Expressions (18) and (19) or the like.

Q(p)=Q₀(p)Q₂(p) (18)

Q(p)=Q₀(p)Q₁(p)Q₂(p) (19)

An operation of the three-dimensional video display apparatus in FIG. 5 will be described below with reference to FIG. 6.

When processing starts, the viewpoint image generator 121 generates viewpoint images based on the video signal 14 and the depth signal 15. The viewpoint image generator 121 selects a display order for the viewpoint images in accordance with the user control signal 11, and supplies a resulting three-dimensional video signal 16 to the display 104 (step S221).

Then, the quality-of-view calculator 122 calculates the quality of view for each viewing position based on the characteristics of the display 104, the display order selected by the viewpoint image generator 121 in step S221, and the viewpoint corresponding to the video signal 14 (step S222).

As described above, the three-dimensional video display apparatus according to the third embodiment generates viewpoint images based on the video signal and the depth signal, and selects a display order for the viewpoint images so that one of the viewpoint images which has a small amount of parallax is guided to the specified position. Thus, the three-dimensional video display apparatus according to the present embodiment can restrain the quality of a three-dimensional image from being degraded by occlusion.

In the present embodiment, the quality-of-view calculator 122 calculates the quality of view for each viewing position based on the characteristics of the display 104, the display order selected by the viewpoint image generator 121, and the viewpoint corresponding to the video signal 14. Here, the number of possible display orders one of which is selected by the viewpoint image generator 121 (that is, the number of viewpoints) is finite. Furthermore, the number of possible viewpoints corresponding to the video signal 14 is finite or the viewpoint corresponding to the video signal may be fixed (for example, the central viewpoint). That is, maps can be generated by calculating the quality of view for each viewing position expected to result from each display order (and each viewpoint for the video signal 14). The thus pre-generated maps associated with the respective display orders (and the respective viewpoints for the video signal 14) are saved in a storage (memory or the like), and a map corresponding to the display order selected by the viewpoint image generator 121 and the viewpoint for the video signal 14 is read when the three-dimensional video is displayed. Then, similar effects can be exerted even when the quality-of-view calculator 122 and the map generator 102 are replaced with the storage. Thus, the present embodiment also aims to provide a map generation apparatus including the quality-of-view calculator 122, the map generator 102, and a storage (not shown in the drawings). Moreover, the present embodiment aims to provide a three-dimensional video display apparatus including a storage (not shown in the drawings) in which maps pre-generated by the map generation apparatus and associated with the respective display orders (and the respective viewpoints for the video signal 14) are stored, the viewpoint image generator 121, (the selector 103 as needed,) and the display 104.

### Fourth Embodiment

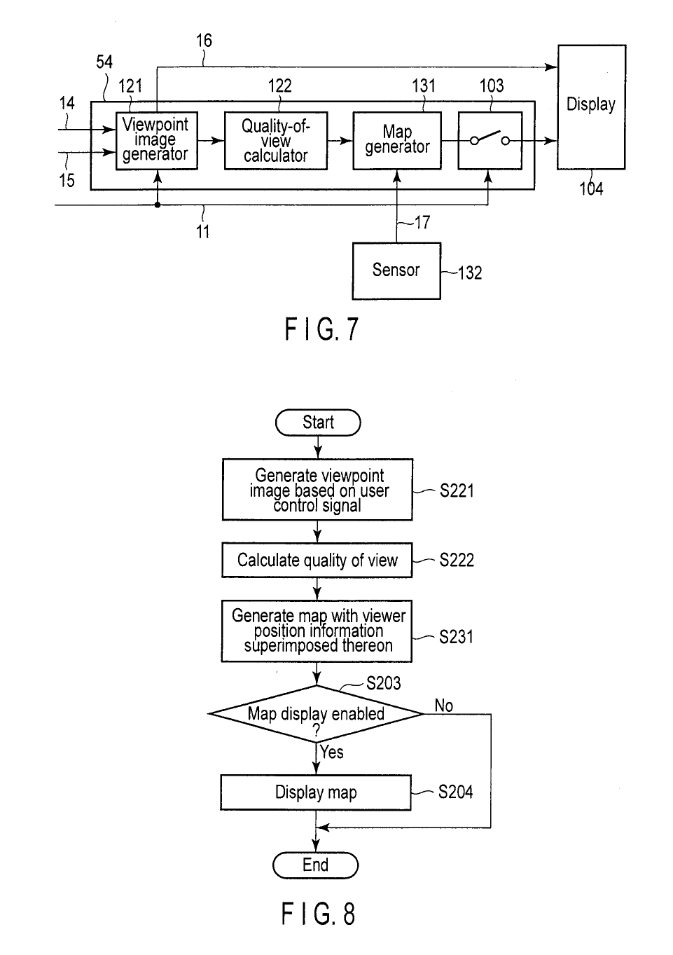

As shown in FIG. 7, a three-dimensional video display apparatus according to a fourth embodiment comprises a presenter 54, a sensor 132, and a display 104. The presenter 54 includes a viewpoint image generator 121, a quality-of-view calculator 122, a map generator 131, and a selector 103. The viewpoint image generator 121 and the quality-of-view calculator 122 may be replaced with a quality-of-view calculator 101 or with a viewpoint selector 111 and a quality-of-view calculator 112.

The sensor 132 detects position information on the viewer (hereinafter referred to as viewer position information 17). For example, the sensor 132 may detect the viewer position information 17 by utilizing a face recognition technique or any other technique known in the fields of motion sensors and the like.

Like the map generator 102, the map generator 131 generates a map according to the quality of view for each viewing position. Moreover, the map generator 131 superimposes the viewer position information 17 on the map and supplies the resulting map to the selector 103. For example, the map generator 131 additionally places a predetermined symbol (for example, a circle, a cross, or a mark that identifies a particular viewer [for example, a preset face mark]) at a position in the map which corresponds to the viewer information 17.

An operation of the three-dimensional video display apparatus in FIG. 7 will be described below with reference to FIG. 8.

After step S222 (or step S202 or step S212) ends, the map generator 131 generates a map according to the calculated quality of view. The map generator 131 superimposes the viewer position information 17 detected by the sensor 132 on the map, and supplies the resulting map to the selector 103 (step S231). The processing proceeds to step S203.

As described above, the three-dimensional video display apparatus according to the fourth embodiment generates a map with the viewer position information superimposed thereon. Thus, the three-dimensional video display apparatus according to the present embodiment allows the viewer to recognize the viewer's own position in the map and to carry out smooth movement, selection of the viewpoint, and the like.

In the present embodiment, the map generated by the map generator 131 according to the quality of view can be pre-generated and stored in a storage (not shown in the drawings) as described above. That is, when the map generator 131 reads the appropriate map from the storage, and superimposes the viewer position information 17 on the map, similar effects can be exerted even when the quality-of-view calculator 122 in FIG. 7 is replaced with the storage. Thus, the present embodiment also aims to provide a three-dimensional video display apparatus including a storage (not shown in the drawings) in which maps pre-generated are stored, the map generator 131 which reads a map stored in the storage and which superimposes the viewer position information 17 on the map, the viewpoint image generator 121, (the selector 103 as needed,) and the display 104.

### Fifth Embodiment

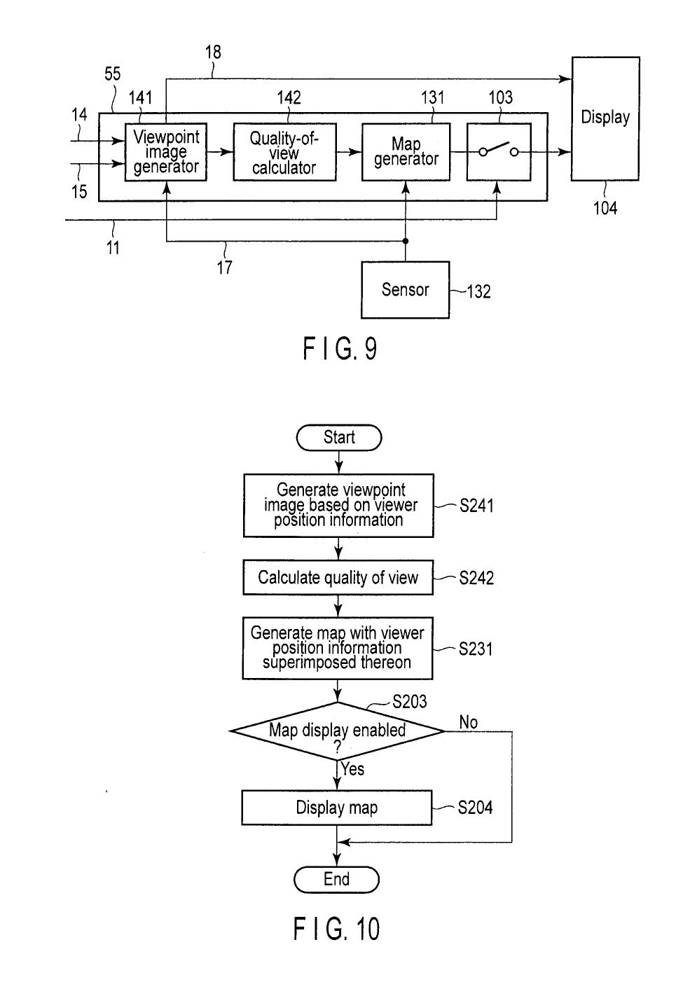

As shown in FIG. 9, a three-dimensional video display apparatus according to a fifth embodiment comprises a presenter 55, a sensor 132, and a display 104. The presenter 55 includes a viewpoint image generator 141, a quality-of-view calculator 142, a map generator 131, and a selector 103. The map generator 131 may be replaced with a map generator 102.

Unlike the above-described viewpoint image generator 121, the viewpoint image generator 141 generates viewpoint images based on a video signal 14 and a depth signal 15 in accordance with viewer position information 17 instead of a user control signal 11, and supplies the display 104 with a three-dimensional video signal 18 containing the generated viewpoint images. Specifically, the viewpoint image generator 141 selects a display order for the generated viewpoint images so as to improve the quality of a three-dimensional video perceived at the current viewer position. For example, with at least three viewpoints, the viewpoint image generator 141 selects a display order for the viewpoint images so as to guide a viewpoint image with a small amount of parallax (from the video signal 14) is guided to the current viewer position. With two viewpoints, the viewpoint image generator 141 selects a display order for the viewpoint images so that the current viewer position is included in the region of normal stereoscopy. The quality-of-view calculator 142 is notified of the display order selected by the viewpoint image generator 141 and the viewpoint corresponding to the video signal 14.

The viewpoint image generator 141 may select a technique to generate a viewpoint image depending on the detection accuracy of the sensor 132. Specifically, if the detection accuracy of the sensor 132 is lower than a threshold, the viewpoint image generator 141, like the viewpoint image generator 121, may generate viewpoint images in accordance with the user control signal 11. On the other hand, if the detection accuracy of the sensor 132 is equal to or higher than the threshold, the viewpoint image generator 141 generates viewpoint images in accordance with the viewer position information 17.

Alternatively, the viewpoint image generator 141 may be replaced with a viewpoint image selector which receives a three-dimensional video signal 12 to select a display order for a plurality of viewpoint images contained in the three-dimensional video signal 12, in accordance with the viewer position information 17. The viewpoint image selector selects the display order for the viewpoint images, for example, so that the current viewing position is included in the region of normal stereoscopy or so as to maximize the quality of view at the current viewing position.

Like the quality-of-view calculator 122, the quality-of-view calculator 142 calculates the quality of view for each viewing position based on the characteristics of the display 104, the display order selected by the viewpoint image generator 121, and the viewpoint corresponding to the video signal 14. The quality-of-view calculator 142 inputs the calculated quality of view for each viewing position to the map generator 131.

An operation of the three-dimensional video display apparatus in FIG. 9 will be described below with reference to FIG. 10.

When processing starts, the viewpoint image generator 141 generates viewpoint images based on a video signal 14 and a depth signal 15. The viewpoint image generator 141 selects a display order for the viewpoint images in accordance with the viewer position information 17 detected by the sensor 132, and supplies a resulting three-dimensional video signal 18 to the display 104 (step S241).

Then, the quality-of-view calculator 142 calculates the quality of view for each viewing position based on the characteristics of the display 104, the display order selected by the viewpoint image generator 141 in step S241, and the viewpoint corresponding to the video signal 14 (step S242).

As described above, the three-dimensional video display apparatus according to the fifth embodiment automatically generates a three-dimensional video signal in accordance with viewer position information. Thus, the three-dimensional video display apparatus according to the present embodiment allows the viewer to view high-quality three-dimensional videos without the need for viewer's movement or operation.

In the present embodiment, the quality-of-view calculator 142, like the quality-of-view calculator 122, calculates the quality of view for each viewing position based on the characteristics of the display 104, the display order selected by the viewpoint image generator 141, and the viewpoint corresponding to the video signal 14. That is, maps can be pre-generated by calculating the quality of view for each viewing position expected to result from each display order (and each viewpoint for the video signal 14). The thus pre-generated maps associated with the respective display orders (and the respective viewpoints for the video signal 14) are saved in a storage (memory or the like), and a map corresponding to the display order selected by the viewpoint image generator 141 and the viewpoint for the video signal 14 is read when the three-dimensional video is displayed. Then, similar effects can be exerted even when the quality-of-view calculator 142 in FIG. 9 is replaced with the storage. Thus, the present embodiment also aims to provide a map generation apparatus including the quality-of-view calculator 142, the map generator 102, and a storage (not shown in the drawings). Moreover, the present embodiment aims to provide a three-dimensional video display apparatus including a storage (not shown in the drawings) in which maps pre-generated by the map generation apparatus are stored, the map generator 131 which reads a map stored in the storage and which superimposes the viewer position information 17 on the map, the viewpoint image generator 141, (the selector 103 as needed,) and the display 104.

The processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional video display apparatus comprising:
a display configured to display a plurality of images with different viewpoints by using a plurality of light beam control elements to control light beams from pixels;
a calculator configured to calculate a quality of view for each of viewing positions with respect to the display based on a number of the light beam control elements causing pseudoscopy at each of the viewing positions; and
a generator configured to generate a map indicating the quality of view for each of the viewing positions.

2. The apparatus according to claim 1, wherein the calculator calculates the quality of view further based on a position of each of the light beam control elements which cause pseudoscopy at each of the viewing positions.

3. The apparatus according to claim 1, wherein the calculator calculates the quality of view further based on a deviation from a preset ideal viewing position.

4. The apparatus according to claim 1, wherein the generator generates the map by expressing the quality of view for each of the viewing position by a corresponding color.

5. The apparatus according to claim 1, further comprising a determiner configured to determine whether the map is displayed on the display or not in accordance with a user's control.

6. The apparatus according to claim 1, further comprising a selector configured to select a display order for the plurality of images in the display so as to maximize the quality of view at a specified position in accordance with a user's control.

7. The apparatus according to claim 1, further comprising an image generator configured to generate the plurality of images based on a video signal and a depth signal and to select a display order for the plurality of images in the display in accordance with a user's control.

8. The apparatus according to claim 1, further comprising a sensor configured to detect a viewer's position, and wherein the generator superimposes information indicating the viewer's position on the map.

9. The apparatus according to claim 1, further comprising:
a sensor configured to detect a viewer's position; and
an image generator configured to generate the plurality of images based on a video signal and a depth signal and to select a display order for the plurality of images in the display in accordance the viewer's position.

10. A three-dimensional video display method comprising:
displaying a plurality of images with different viewpoints on a display by using a plurality of light beam control elements to control light beams from pixels;
calculating a quality of view for each of viewing positions with respect to the display based on a number of the light beam control elements causing pseudoscopy at each of the viewing positions; and
generating a map indicating the quality of view for each of the viewing positions.
